(19) United States
(12) Patent Application Publication
(10) Pub. No.: US 2003/0201621 A1
(43) Pub. Date: Oct. 30, 2003

(54) Vehicle having auxiliary controlling device

(76) Inventor: Jiann Lian Jang, Tainan Hsien (TW)

Correspondence Address: CHARLES E. BAXLEY, 5th Floor, 59 John Street, New York, NY, 10038, US

(21) Appl. No.: 10/134,855

(22) Filed: Apr. 30, 2002

(51) Int. Cl. B62H 7/00

(52) U.S. Cl. 280/293

(57) ABSTRACT

A vehicle includes a rotatable frame having a front wheel device. A tube is rotatably secured to the rear portion of the vehicle and has a lower portion pivotally coupled to the frame with a lever, in order to rotate the front wheel device when the tube is rotated relative to the vehicle from the rear portion of the vehicle. The parents may thus control the vehicle from the rear portion of the vehicle, in order to train and to help the children to ride the vehicle. A housing may be attached to the lever, and a spring may be engaged between the housing and the lever.

### BACKGROUND OF THE INVENTION

1. Field of the Invention

The present invention relates to a vehicle, and more particularly to a vehicle or a cycle or a tricycle having an auxiliary controlling device.

2. Description of the Prior Art

Various kinds of typical vehicles, such as the toy vehicles, the tricycles, or the other cycles have been developed for children to ride and to learn how to ride the vehicles. For the children who may not ride the vehicles, the parents will be difficult to control or to steer or to maneuver the vehicles, particularly in the back or the rear portion of the vehicles.

The present invention has arisen to mitigate and/or obviate the afore-described disadvantages of the conventional vehicles.

### SUMMARY OF THE INVENTION

The primary objective of the present invention is to provide a vehicle including an auxiliary controlling device for allowing the parents to control or to steer or to maneuver the vehicles, particularly in the back or the rear portion of the vehicles.

The other objective of the present invention is to provide a vehicle including an auxiliary controlling device for helping the children to learn to ride the vehicles.

In accordance with one aspect of the invention, there is provided a vehicle comprising a vehicle body including a rear portion having a rear wheel device attached thereto, and including a front portion, a frame pivotally secured to the front portion of the vehicle body with a pivot axle, and including a lower portion having a front wheel device attached thereto, and including an upper portion, a tube rotatably secured to the rear portion of the vehicle body, and including a lower portion, a lever including a first end pivotally coupled to the frame, and a second end pivotally coupled to the lower portion of the tube. The frame and the front wheel device are rotatable about the pivot axle by the lever, when the tube is rotated relative to the vehicle body.

The frame includes a first pin extended therefrom and rotatably engaged through the first end of the lever, the tube includes a second pin extended therefrom and rotatably engaged through the second end of the lever.

The lever includes an oblong hole formed in the first end thereof for slidably receiving the first pin, and includes an oblong hole formed in the second end thereof for slidably receiving the second pin.

The frame includes a first bar extended therefrom and having the first pin extended from the first bar, and the tube includes a second bar extended therefrom and having the second pin extended from the second bar.

A hand grip may further be provided and detachably secured to the tube for rotating the tube relative to the vehicle body.

A housing includes a channel formed therein for receiving the lever, and for attaching the housing onto the lever.

A device may further be provided for centering the lever relative to the housing, and includes at least one spring engaged between the housing and the lever.

The housing includes at least one groove formed therein, the spring includes a leg engaged in the groove of the housing, and a spring blade engaged with the lever.

A fastener may further be provided and engaged through the housing and the lever for rotatably securing the housing to the lever.

The lever includes a middle portion having an oblong hole formed therein for slidably receiving the fastener.

A post may further be provided and pivotally secured to the housing and having a foot pedal device provided thereon.

The housing includes a casing extended downward therefrom, the post includes an upper end pivotally secured to the casing with a pivot shaft.

The casing includes at least one notch formed therein, the post includes a spring-biased projection provided thereon for selectively engaging with the notch of the casing and for securing the post to the casing at a selected angular position.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a vehicle in accordance with the present invention;

FIG. 2 is a partial exploded view of the vehicle;

FIG. 3 is a another partial exploded view of the vehicle;

FIGS. 4, 5 are perspective view illustrating the operation of the vehicle; and

FIGS. 6, 7 are top plan views illustrating the operation of the vehicle.

### DETAILED DESCRIPTION OF THE PREFERRED EMBODIMENT

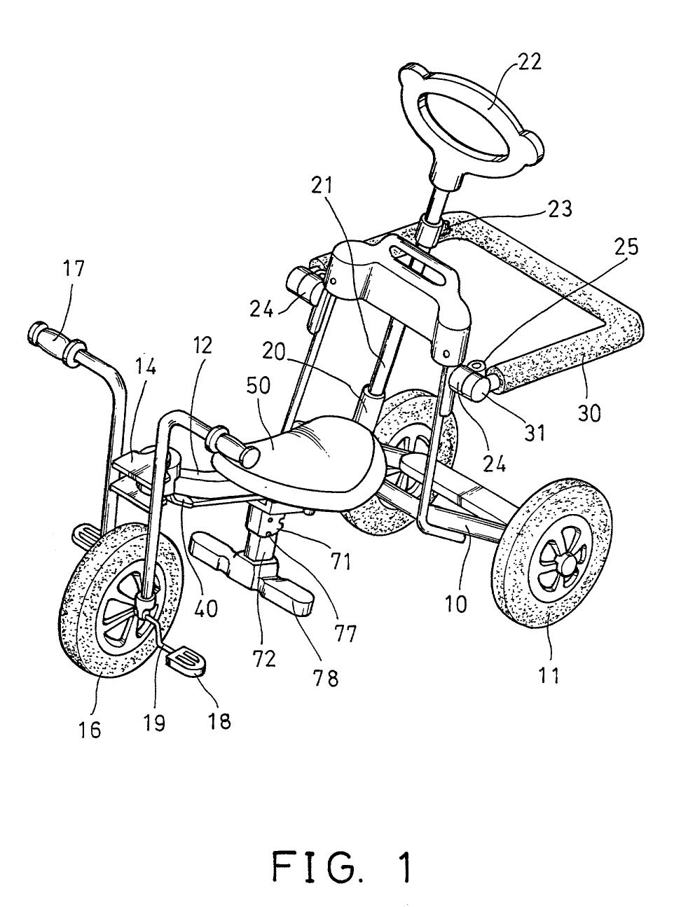

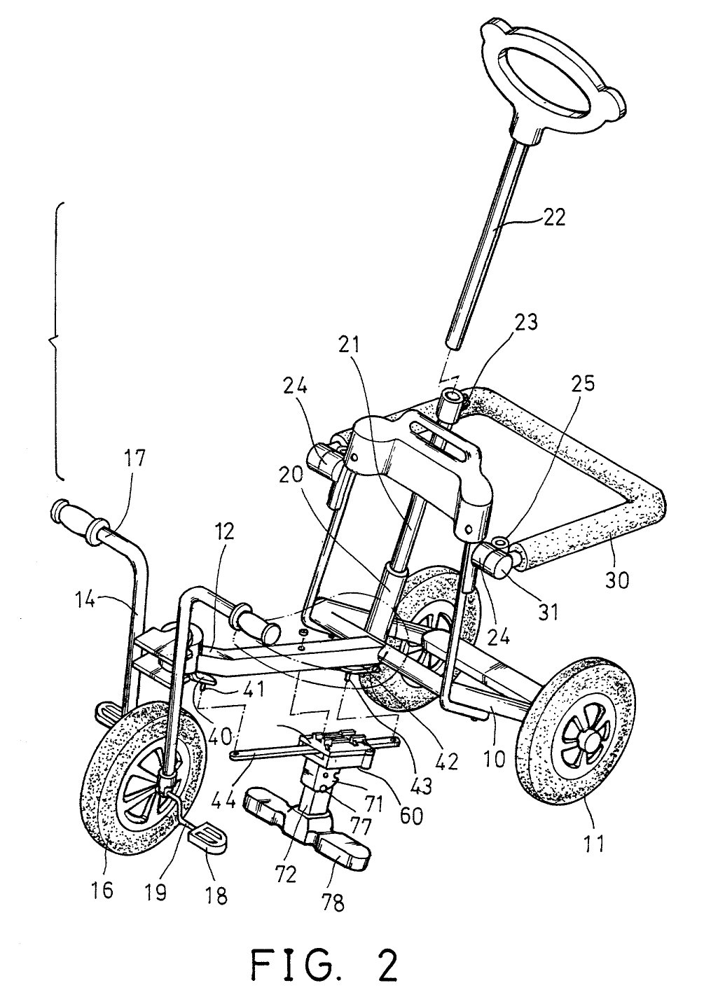

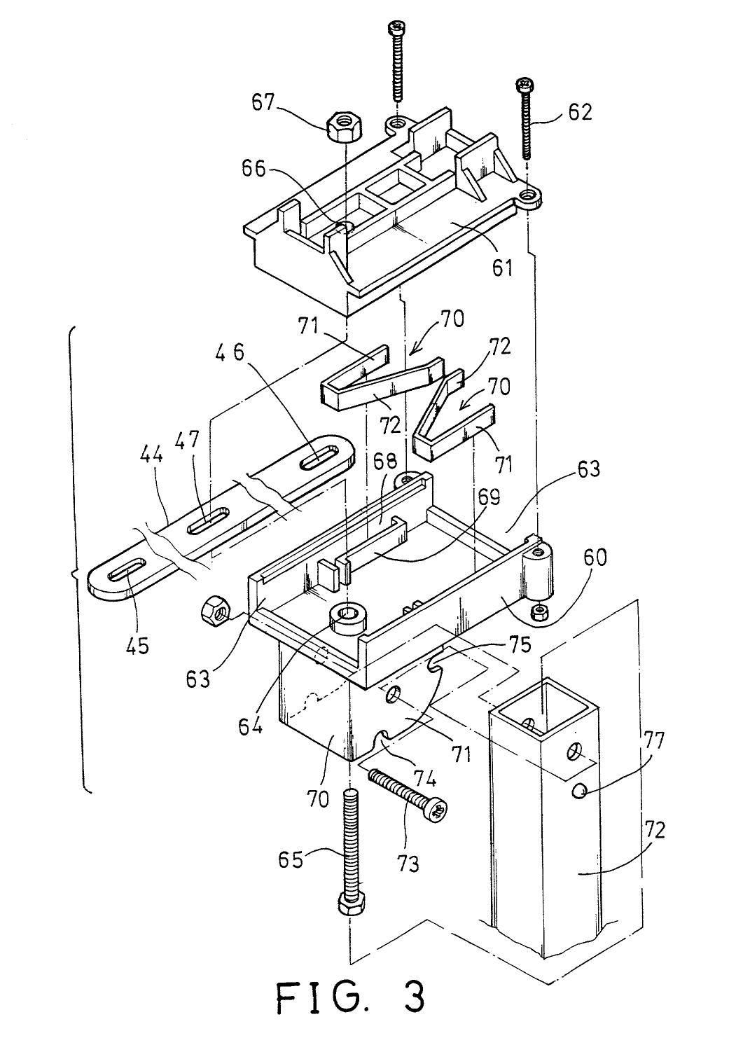

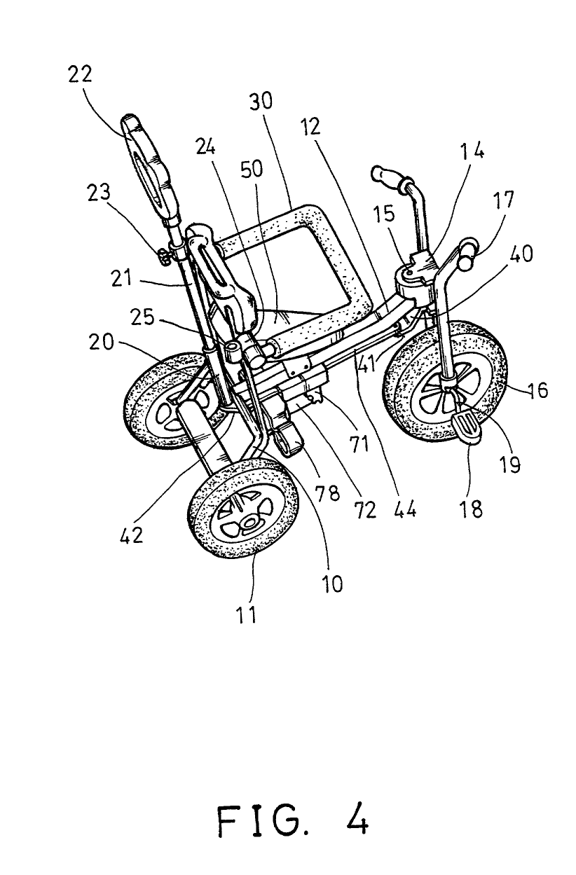

Referring to the drawings, and initially to FIGS. 1-3, a vehicle in accordance with the present invention comprises a vehicle member or body 10 including a rear wheel device 11, such as one or more rear wheels 11 attached to the rear portion thereof, and including a beam 12 provided in the middle or the front portion thereof. A frame 14 is rotatably secured to the front portion of the beam 12 with a pivot axle 15 (FIGS. 4, 6, 7), and includes a front wheel device 16, such as one or more front wheels 16 attached to the bottom portion thereof, and including a handle 17 provided on top thereof. A pair of foot pedals 18 are coupled to the front wheel(s) 16 with a pair of cranks 19, in order to rotate and to drive the vehicle.

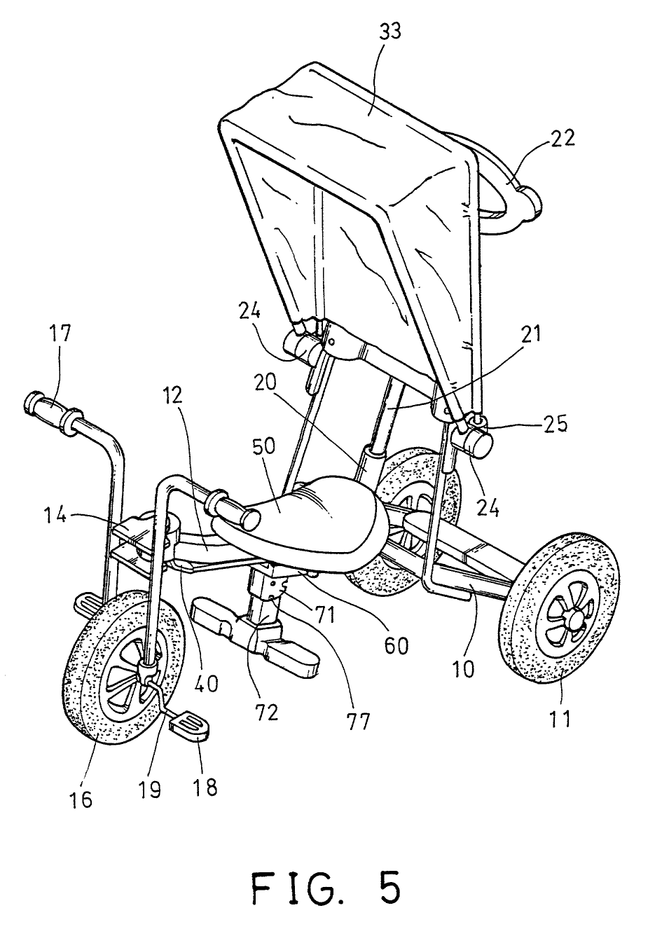

A hub 20 is vertically provided on the rear portion of the vehicle body 10. A tube 21 is rotatably secured in the hub 20. A hand grip 22 may be detachably and selectively secured on top of the tube 21 with one or more fasteners 23. The vehicle body 10 includes a pair of sockets 24 provided on the rear portion thereof, and a barrel 25 secured to each of the sockets 24. A protective arm 30 includes a U-shaped structure having two couplers 31 provided on the ends thereof for rotatably securing to the sockets 24 respectively, and having a positioning device (not shown) for selectively securing the arm 30 to the sockets 24 of the vehicle body 10 at any selected angular positions (FIGS. 1, 2, 4). A hood or a canopy 33 (FIG. 5) may further be provided and attached to the sockets 24 and/or the barrels 25 of the vehicle body 10.

The frame 14 includes a pin 41 extended therefrom. or includes a bar 40 extended therefrom and having the pin 41 extended from the bar 40. The tube 21 also includes a pin 43 extended therefrom, or includes a bar 42 extended therefrom and having the pin 43 extended from the bar 42. A lever 44 includes two ends each having an oblong hole 45, 46 formed therein for slidably receiving the pins 41, 43, and a middle portion having another oblong hole 47 formed therein.

A housing 60 includes a cover 61 secured on top thereof with one or more fasteners 62, and includes a channel 63 formed therein for slidably receiving the lever 44, and includes an orifice 64 formed therein for aligning with the oblong hole 47 of the lever 44. A fastener 65 may be engaged through the orifice 64 of the housing 60 and the oblong hole 47 of the lever 44, and may also be engaged through an aperture 66 of the cover 61, for slidably locking the lever 44 to the housing 60 with such as a lock nut 67. The housing 60 may be slid or adjusted or moved along the lever 44 when the fastener 65 is disengaged from the housing 60.

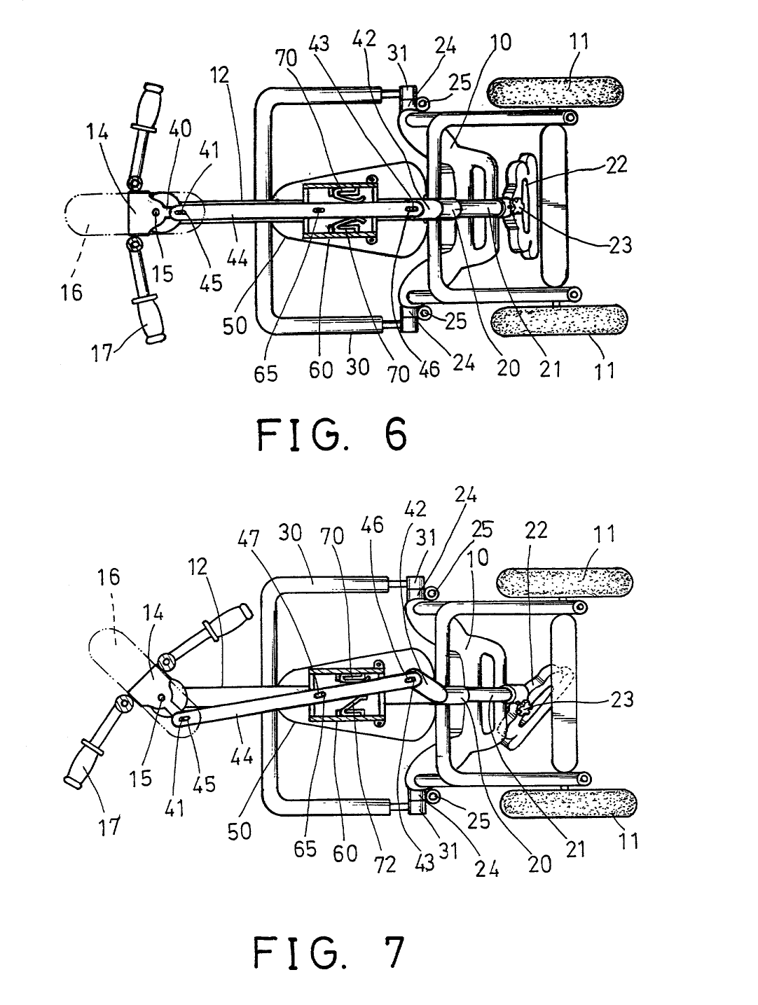

The housing 60 further includes one or more, such as two grooves 68 formed therein and formed or defined by a pair of partitions 69. One or more. such as two spring members 70, each includes a leg 71 engaged in the grooves 68 and secured to the housing 60, with such as a force-fitted engagement, and each includes a spring blade 72 for engaging with the lever 44 and for centering or for recovering the lever 44, when the forces applied to the lever 44 has been released, for example, best shown in FIGS. 6 and 7.

The housing 60 includes a casing 70 extended downward therefrom or attached to the bottom thereof. The casing 70 includes a pair of side walls 71 each or both having two notches 74, 75 formed therein. A post 72 includes an upper end engaged into the casing 70 and engaged between the side walls 71 and rotatably secured to the casing 70 with a pivot shaft 73, and includes one or more foot pedals 78 attached to the bottom thereof. The post 72 includes one or more spring-biased projection 77 provided thereon for selectively engaging with the notches 74, 75 of the casing 70 and for securing the post 72 to the casing 70 at the horizontal or folding or storing position (FIG. 4), or at the downward extending working position (FIGS. 1, 2, 5).

In operation, as shown in FIG. 4. the post 72 and the foot pedals 78 may be folded rearward to the storing or folding position when the children do not require the foot pedals 78, and when the children may ride the vehicle with the foot pedals 18 by themselves. As shown in FIGS. 1, 2, 5, the post 72 and thus the foot pedals 78 may be rotated downward to the downward working position when the children may not ride the vehicle with the foot pedals 18 by themselves. A seat cushion 50 may be provided and disposed on the beam 12 for supporting the children.

As shown in FIGS. 6, 7, the parents who are standing behind the vehicle, may also use the hand grip 22 to rotate the lever 44, in order to rotate the frame 14 and the front wheel 16, and so as to control or maneuver the vehicle from the rear portion of the vehicle. The hand grip 22 may thus be used as an auxiliary controlling device to control or to maneuver the vehicles, and to help the children to ride the vehicles.

Accordingly, the vehicle in accordance with the present invention includes an auxiliary controlling device for allowing the parents to control or to steer or to maneuver the vehicles, particularly in the back or the rear portion of the vehicles, and for helping the children to learn to ride the vehicles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A vehicle comprising:
a vehicle body including a rear portion having a rear wheel device attached thereto, and including a front portion,
a frame pivotally secured to said front portion of said vehicle body with a pivot axle, and including a lower portion having a front wheel device attached thereto, and including an upper portion,
a tube rotatably secured to said rear portion of said vehicle body, and including a lower portion,
a lever including a first end pivotally coupled to said frame, and a second end pivotally coupled to said lower portion of said tube,
said frame and said front wheel device being rotatable about said pivot axle by said lever, when said tube is rotated relative to said vehicle body.

2. The vehicle according to claim 1, wherein said frame includes a first pin extended therefrom and rotatably engaged through said first end of said lever, said tube includes a second pin extended therefrom and rotatably engaged through said second end of said lever.

3. The vehicle according to claim 2, wherein said lever includes an oblong hole formed in said first end thereof for slidably receiving said first pin, and includes an oblong hole formed in said second end thereof for slidably receiving said second pin.

4. The vehicle according to claim 2, wherein said frame includes a first bar extended therefrom and having said first pin extended from said first bar, and said tube includes a second bar extended therefrom and having said second pin extended from said second bar.

5. The vehicle according to claim 1 further comprising a hand grip detachably secured to said tube for rotating said tube relative to said vehicle body.

6. The vehicle according to claim 1 further comprising a housing including a channel formed therein for receiving said lever, and for attaching said housing onto said lever.

7. The vehicle according to claim 6 further comprising means for centering said lever relative to said housing.

8. The vehicle according to claim 7, wherein said centering means includes at least one spring engaged between said housing and said lever.

9. The vehicle according to claim 8, wherein said housing includes at least one groove formed therein, said at least one spring includes a leg engaged in said at least one groove of said housing, and a spring blade engaged with said lever.

10. The vehicle according to claim 6 further comprising a fastener engaged through said housing and said lever for rotatably securing said housing to said lever.

11. The vehicle according to claim 10, wherein said lever includes a middle portion having an oblong hole formed therein for slidably receiving said fastener.

12. The vehicle according to claim 6 further comprising a post pivotally secured to said housing and having a foot pedal device provided thereon.

13. The vehicle according to claim 12, wherein said housing includes a casing extended downward therefrom, said post includes an upper end pivotally secured to said casing with a pivot shaft.

14. The vehicle according to claim 13, wherein said casing includes at least one notch formed therein, said post includes a spring-biased projection provided thereon for selectively engaging with said at least one notch of said casing and for securing said post to said casing at a selected angular position.
